(19) United States
(12) Patent Application Publication
(10) Pub. No.: US 2016/0112253 A1
(43) Pub. Date: Apr. 21, 2016

(54) SHARED FRAMEWORK FOR OPTICAL NETWORK SPAN BASED GRAPHICAL APPLICATIONS

(71) Applicant: Infinera Corporation, Sunnyvale, CA (US)

(72) Inventors: Karthikeyan M. Nagarajan, Bangalore (IN); Yashpal Kumar, Bangalore (IN); Pydi Kasi Viswanadham, Bangalore (IN); Prashanth Kota, Bangalore (IN); Maneesh Jain, Dehradun (IN); Lam D. Hoang, San Jose, CA (US); Dharmendra Naik, San Jose, CA (US); Raj Venkatesan, Saratoga, CA (US)

(21) Appl. No.: 14/514,887

(22) Filed: Oct. 15, 2014

(51) Int. Cl. H04L 12/24; G06F 3/0484; H04B 10/27

(52) U.S. Cl. CPC H04L 41/0803; H04B 10/27; G06F 3/04842

(57) ABSTRACT

A device may receive a request to present, via a user interface, information associated with an optical network. The information associated with the optical network may be stored using a data structure accessible to provide the information to one or more applications associated with one or more view types. The device may identify an application or a view type associated with the user interface. The device may identify an optical equipment type associated with the request. The optical equipment type may identify a type of optical equipment, associated with the optical network, to be presented for display via the user interface. The device may identify formatting information, for presenting optical network information associated with the optical equipment, based on the optical equipment type and the view type or the application. The device may provide the optical network information, for presentation via the user interface, based on the formatting information.

### BACKGROUND

In optical networks, signals may be transmitted at various wavelengths, with each wavelength corresponding to a transmission channel. Optical links may connect network nodes so that signals may be transmitted throughout the optical network. An optical route may use a series of network nodes and optical links to connect a source of an optical transmission with a destination for the optical transmission.

### SUMMARY

According to some possible implementations, a device may receive a request to present, via a user interface, information associated with an optical network. The information associated with the optical network may be stored using a data structure accessible to provide the information to one or more applications associated with one or more view types. The device may identify an application, of the one or more applications, or a view type, of the one or more view types, associated with the user interface. The device may identify an optical equipment type associated with the request. The optical equipment type may identify a type of optical equipment, associated with the optical network, to be presented for display via the user interface. The device may identify formatting information, for presenting optical network information associated with the optical equipment, based on the optical equipment type and at least one of the view type or the application. The device may provide the optical network information, for presentation via the user interface, based on the formatting information.

According to some possible implementations, a computer-readable medium may store instructions that cause a processor to receive a request to render, via a user interface, information associated with an optical network. The information associated with the optical network may be stored using a data structure accessible to provide the information for rendering via one or more applications or one or more view types of the one or more applications. The instructions may cause the processor to identify an application, of the one or more applications, or a view type, of the one or more view types, associated with the user interface. The instructions may cause the processor to identify an optical equipment type associated with the request. The optical equipment type may identify a type of optical equipment, associated with the optical network, to be rendered for display via the user interface. The instructions may cause the processor to identify formatting information, for rendering optical network information associated with the optical equipment, based on the optical equipment type and at least one of the view type or the application. The instructions may cause the processor to provide the optical network information, for rendering via the user interface, based on the formatting information.

According to some possible implementations, a method may include receiving, by a device, a request to provide information associated with an optical network. The information associated with the optical network may be stored using a data structure accessible to provide the information to one or more applications. The method may include identifying, by the device, an application, of the one or more applications, to which the information associated with the optical network is to be provided. The method may include identifying, by the device, an optical equipment type associated with the request. The optical equipment type may identify a type of optical equipment associated with the optical network. The method may include identifying, by the device, formatting information, for providing optical network information associated with the optical equipment to the application, based on the optical equipment type and the application. The method may include providing, by the device, the optical network information to the application based on the formatting information.

### BRIEF DESCRIPTION OF THE DRAWINGS

FIGS. 1A and 1B are diagrams of an overview of an example implementation described herein;

FIG. 2A is a diagram of an example environment in which systems and/or methods, described herein, may be implemented;

FIG. 2B is a diagram of example devices of an optical network that may be monitored and/or configured according to implementations described herein;

FIG. 2C is a diagram of example super-channels that may be monitored and/or configured according to implementations described herein;

FIG. 3 is a diagram of example components of one or more devices and/or systems of FIG. 2A and/or FIG. 2B;

FIG. 4 is a flow chart of an example process for receiving and storing optical network information and formatting information that controls a manner in which the optical network information is provided for display;

FIGS. 5A-5D are diagrams of an example implementation relating to the example process shown in FIG. 4;

FIG. 6 is a flow chart of an example process for providing optical network information for rendering via a user interface based on formatting information; and

FIGS. 7A-7F are diagrams of an example implementation relating to the example process shown in FIG. 6.

### DETAILED DESCRIPTION

The following detailed description of example implementations refers to the accompanying drawings. The same reference numbers in different drawings may identify the same or similar elements.

Administrators and/or users of an optical network may use different graphical applications to monitor, troubleshoot, configure, and/or view information associated with the optical network. These graphical applications may use the same optical network information (e.g., information associated with an optical link, an optical device, an optical component, an optical super-channel, an optical channel, or the like), but may provide the optical network information for display in different manners. The graphical applications may use different data structures (e.g., frameworks) to store and organize the optical network information, resulting in inefficient use of computing resources, such as memory and processing power. Implementations described herein use a shared framework data structure to store and organize optical network information for different graphical applications, resulting in more efficient use of computing resources (e.g., processing power, processing time, memory, etc.) and human resources (e.g., software development time, software testing time, etc.).

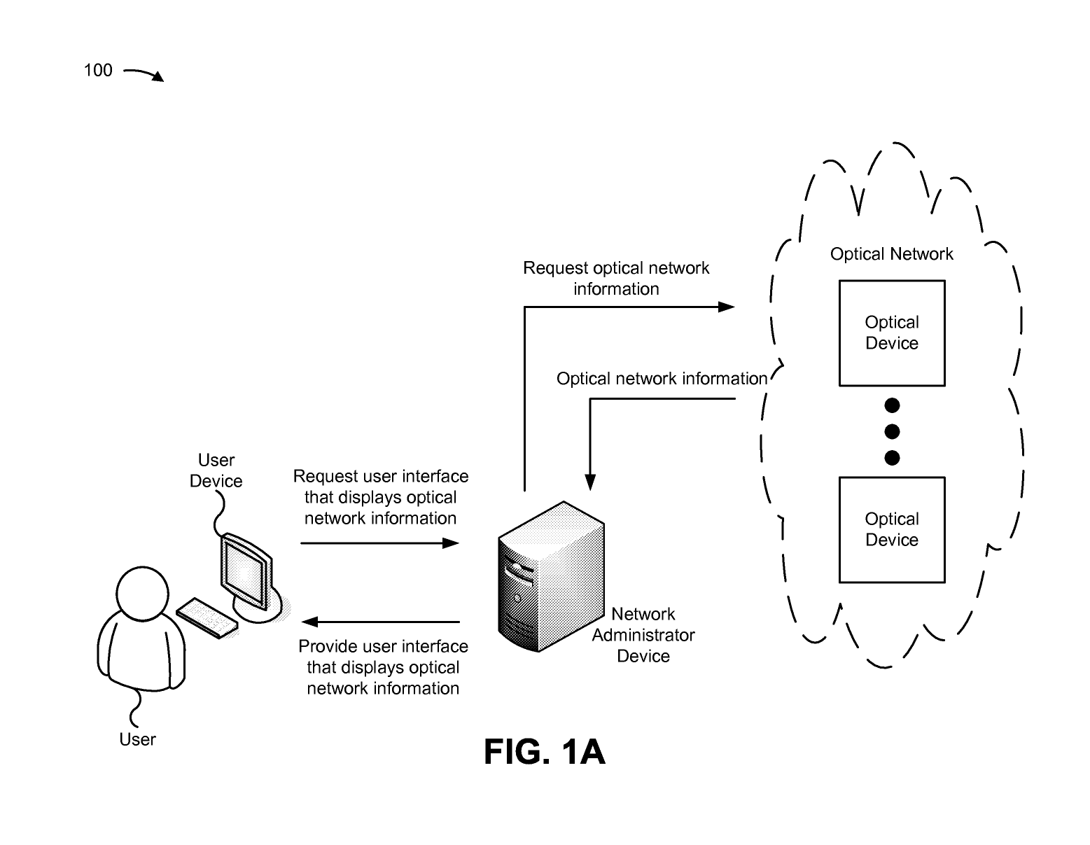

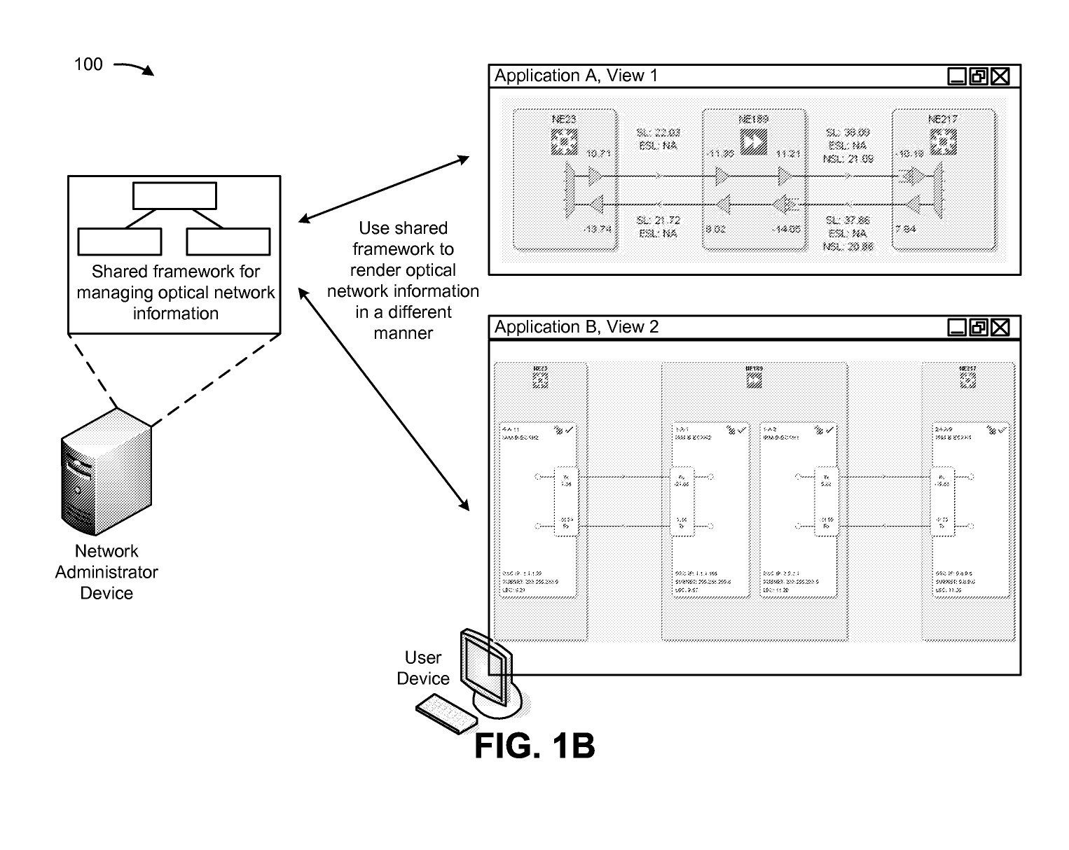

FIGS. 1A and 1B are diagrams of an overview of an example implementation 100 described herein. As shown in FIG. 1A, a user interacting with a user device (e.g., a desktop computer, a laptop computer, etc.) may request, from a network administrator device (e.g., a server, a network device, etc.), a user interface that displays optical network information. The network administrator device may request the optical network information from one or more optical devices in an optical network. The network administrator device may receive the requested optical network information from the optical devices (or may retrieve the requested optical network information from memory), and may provide the optical network information to the user device for display via the user interface.

As shown in FIG. 1B, the network administrator device may use a shared framework (e.g., a data structure) to manage, organize, and store the optical network information. The network administrator device may use the shared framework to render optical network information in a different manner for different graphical applications or different view types of a graphical application. For example, when the user device is executing “Application A” with “View 1,” the network administrator device may provide the optical network information to the user device for display in a first manner, as shown. As further shown, when the user device is executing “Application B” with “View 2,” the network administrator device may provide the optical network information to the user device for display in a second manner. The different applications or different view types may have different purposes, but may use some of the same optical network information. In this way, the network administrator device (e.g., which provides optical network information to the user device) may conserve computing resources by using a shared framework to manage the optical network information, which may be used by the user device, or multiple user devices, for different purposes associated with different applications.

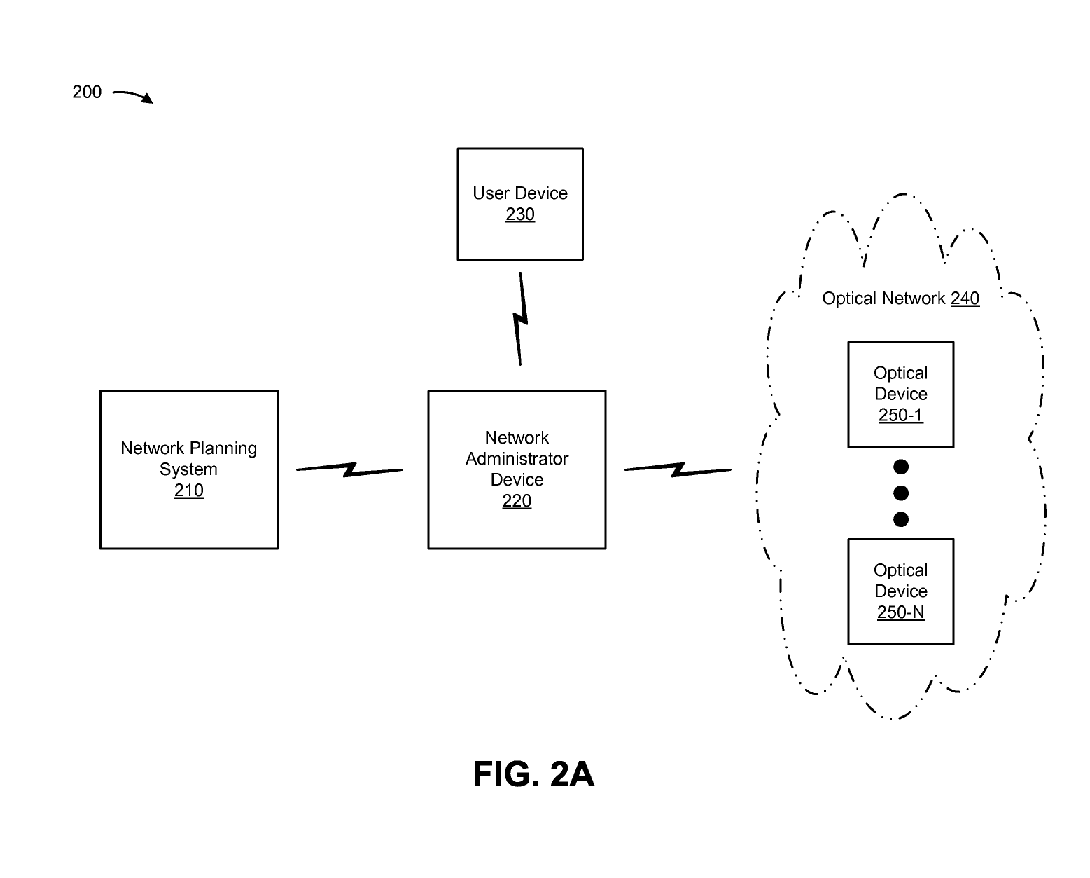

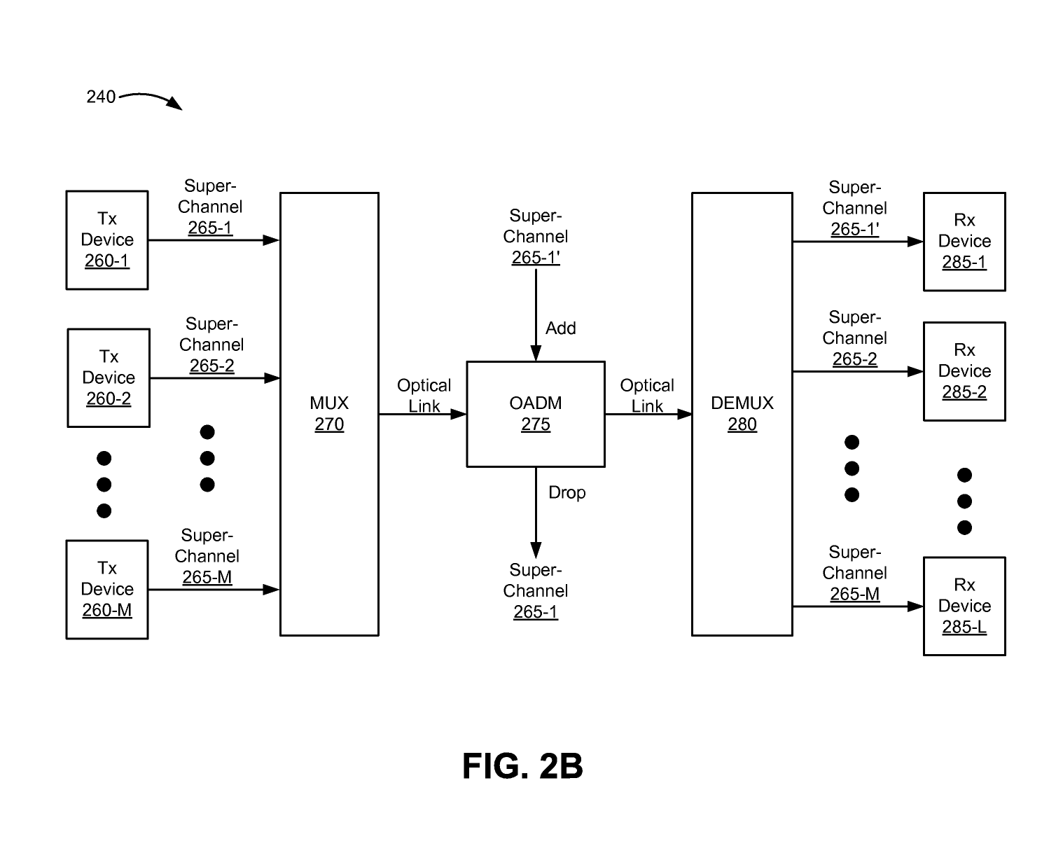

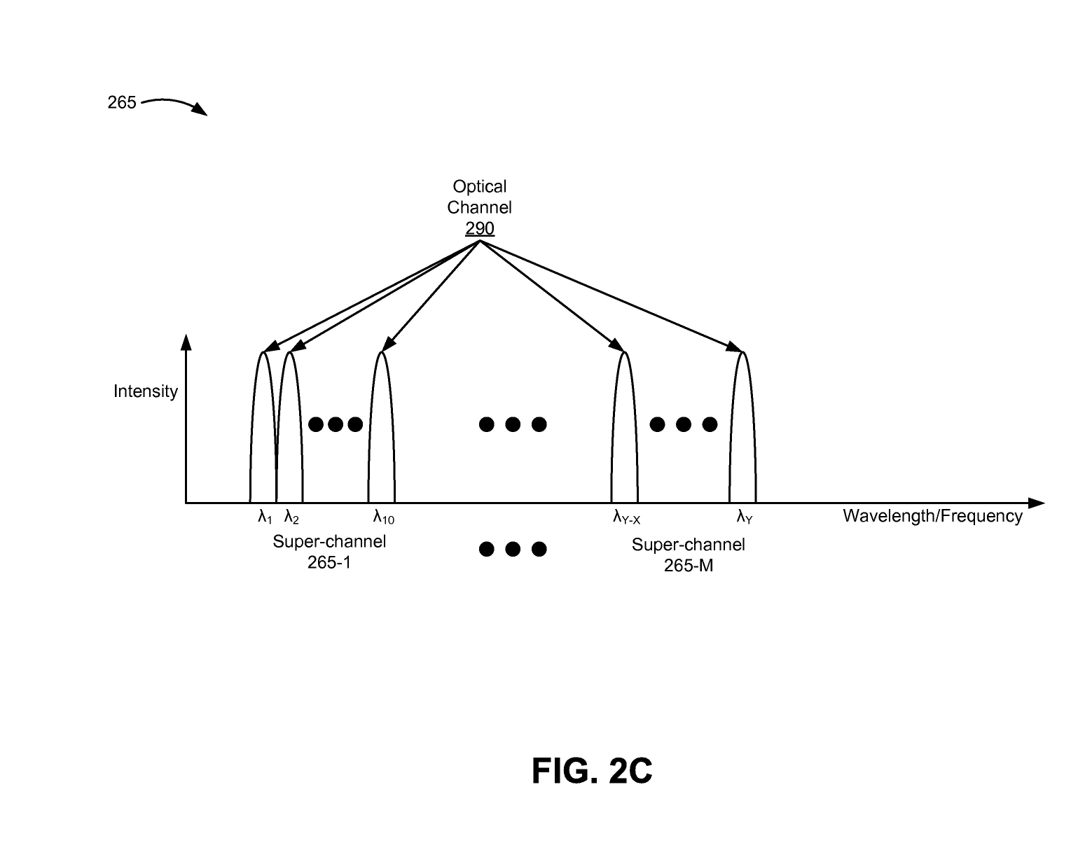

FIG. 2A is a diagram of an example environment 200 in which systems and/or methods, described herein, may be implemented. As shown in FIG. 2A, environment 200 may include a network planning system 210, a network administrator device 220, a user device 230, and an optical network 240, which may include a set of optical devices 250-1 through 250-N (N≧1) (hereinafter referred to individually as “optical device 250,” and collectively as “optical devices 250”). Devices of environment 200 may interconnect via wired connections, wireless connections, or a combination of wired and wireless connections.

Network planning system 210 may include one or more devices capable of receiving, generating, storing, processing, and/or providing optical network information. For example, network planning system 210 may include a computing device, such as a server or a similar type of device. Network planning system 210 may assist a user in modeling and/or planning an optical network, such as optical network 240. For example, network planning system 210 may assist in modeling and/or planning an optical network configuration, which may include quantities, locations, capacities, parameters, and/or configurations of optical devices 250, characteristics and/or configurations (e.g., capacities) of optical links between optical devices 250, traffic demands of optical devices 250 and/or optical links between optical devices 250, and/or any other network information associated with optical network 240 (e.g., optical device configurations, digital device configurations, etc.). Network planning system 210 may provide optical network information, associated with optical network 240, to network administrator device 220 so that a user may view, modify, and/or interact with the optical network information (e.g., via an application).

Network administrator device 220 may include one or more devices capable of receiving, generating, storing, processing, and/or providing optical network information. For example, network administrator device 220 may include a computing device, such as a server, a desktop computer, a laptop computer, or the like. In some implementations, network administrator device 220 may receive optical network information (e.g., from one or more devices shown in FIG. 2A), and may manage (e.g., may store, may organize, etc.) the optical network information using a shared framework that may be used by different applications. Additionally, or alternatively, network administrator device 220 may provide the optical network information to another device, such as user device 230, for display via a user interface. In some implementations, user device 230 may provide the optical network information for display based on formatting information associated with an application that uses the optical network information. In some implementations, network administrator device 220 may receive (e.g., from user device 230) information associated with a modification to optical network 240, and may provide information associated with the modification to optical network 240 and/or optical devices 250 to configure optical network 240 based on the modification.

User device 230 may include one or more devices capable of receiving, generating, storing, processing, and/or providing optical network information. For example, user device 230 may include a computing device, such as a desktop computer, a laptop computer, a tablet computer, a mobile phone (e.g., a smart phone, a radiotelephone, etc.), a handheld computer, or the like. In some implementations, user device 230 may receive optical network information from and/or transmit information to another device in environment 200. User device 230 may provide the optical network information for display based on formatting information associated with an application that requests the optical network information. In some implementations, user device 230 may receive user input to modify optical network information, and may provide the modified optical network information to an optical device 250 (e.g., via network administrator device 220) to cause the modification to be implemented in optical network 240.

Optical network 240 may include any type of network that uses light as a transmission medium. For example, optical network 240 may include a fiber-optic based network, an optical transport network, a light-emitting diode network, a laser diode network, an infrared network, and/or a combination of these or other types of optical networks. Optical network 240 may include one or more optical routes (e.g., optical lightpaths), that may specify a route along which light is carried (e.g., using one or more optical links) between two or more optical devices 250. An optical link may include an optical fiber, an optical control channel, an optical data channel, or the like, and may carry an optical channel (e.g., a signal associated with a particular wavelength of light), an optical super-channel, a super-channel group, an optical carrier group, a set of spectral slices, or the like.

In some implementations, an optical link may carry a set of spectral slices. A spectral slice (a “slice”) may represent a spectrum of a particular size in a frequency band (e.g., 12.5 gigahertz (“GHz”), 6.25 GHz, etc.). For example, a 4.8 terahertz (“THz”) frequency band may include 384 spectral slices, where each spectral slice may represent 12.5 GHz of the 4.8 THz spectrum. A super-channel may include a different quantity of spectral slices depending on the super-channel type.

Optical device 250 may include one or more devices capable of receiving, generating, storing, processing, and/or providing data, carried by an optical signal, via an optical link. For example, optical device 250 may include one or more optical data processing and/or optical traffic transfer devices, such as an optical amplifier (e.g., a doped fiber amplifier, an erbium doped fiber amplifier, a Raman amplifier, etc.), an optical add-drop multiplexer (“OADM”) (e.g., a reconfigurable optical add-drop multiplexer (“ROADM”), a flexibly reconfigurable optical add-drop multiplexer (“FROADM”), etc.), an optical source device (e.g., a laser source), an optical destination device (e.g., a laser sink), an optical multiplexer, an optical demultiplexer, an optical transmitter, an optical receiver, an optical transceiver, a photonic integrated circuit, an integrated optical circuit, or the like. In some implementations, optical device 250 may include one or more optical components. Optical device 250 may process and/or transmit an optical signal (e.g., to another optical device 250 via an optical link) to deliver the optical signal through optical network 240.

The number and arrangement of devices and networks shown in FIG. 2A are provided as an example. In practice, there may be additional devices and/or networks, fewer devices and/or networks, different devices and/or networks, or differently arranged devices and/or networks than those shown in FIG. 2A. Furthermore, two or more devices shown in FIG. 2A may be implemented within a single device, or a single device shown in FIG. 2A may be implemented as multiple, distributed devices. Additionally, or alternatively, a set of devices (e.g., one or more devices) of environment 200 may perform one or more functions described as being performed by another set of devices of environment 200.

FIG. 2B is a diagram of example devices of optical network 240 that may be monitored and/or configured according to implementations described herein. One or more devices shown in FIG. 2B may operate within optical network 240, and may correspond to one or more optical devices 250 and/or one or more optical components of an optical device 250. As shown, optical network 240 may include a set of optical transmitter devices 260-1 through 260-M (M≧1) (hereinafter referred to individually as “Tx device 260,” and collectively as “Tx devices 260”), a set of super-channels 265-1 through 265-M (M≧1) (hereinafter referred to individually as “super-channel 265,” and collectively as “super-channels 265”), a multiplexer (“MUX”) 270, an OADM 275, a demultiplexer (“DEMUX”) 280, and one or more optical receiver devices 285-1 through 285-L (L≧1) (hereinafter referred to individually as “Rx device 285,” and collectively as “Rx devices 285”).

Tx device 260 may include, for example, an optical transmitter and/or an optical transceiver that generates an optical signal. For example, Tx device 260 may include one or more integrated circuits, such as a transmitter photonic integrated circuit (PIC), an application specific integrated circuit (ASIC), or the like. In some implementations, Tx device 260 may include a laser associated with each wavelength, a digital signal processor to process digital signals, a digital-to-analog converter to convert the digital signals to analog signals, a modulator to modulate the output of the laser, and/or a multiplexer to combine each of the modulated outputs (e.g., to form a combined output or WDM signal). One or more optical signals may be carried as super-channel 265. In some implementations, a single Tx device 260 may be associated with a single super-channel 265. In some implementations, a single Tx device 260 may be associated with multiple super-channels 265, or multiple Tx devices 260 may be associated with a single super-channel 265.

Super-channel 265 may include multiple channels multiplexed together using wavelength-division multiplexing to increase transmission capacity. Various quantities of channels may be combined into super-channels using various modulation formats to create different super-channel types having different characteristics. Additionally, or alternatively, an optical link may include a super-channel group. A super-channel group may include multiple super-channels multiplexed together using wavelength-division multiplexing to increase transmission capacity. Super-channel 265 is described in more detail herein in connection with FIG. 2C.

Multiplexer 270 may include, for example, an optical multiplexer (e.g., an arrayed waveguide grating) that combines multiple input super-channels 265 for transmission over an output fiber. For example, multiplexer 270 may combine super-channels 265-1 through 265-M, and may provide the combined super-channels 265 to OADM 275 via an optical link (e.g., a fiber).

OADM 275 may include, for example, a ROADM, a FROADM, or the like. OADM 275 may multiplex, de-multiplex, add, drop, and/or route multiple super-channels 265 into and/or out of a fiber (e.g., a single mode fiber). As illustrated, OADM 275 may drop super-channel 265-1 from a fiber, and may allow super-channels 265-2 through 265-M to continue propagating toward Rx device 285. Dropped super-channel 265-1 may be provided to a device (not shown) that may demodulate and/or otherwise process super-channel 265-1 to output the data stream carried by super-channel 265-1. As illustrated, super-channel 265-1 may be provisioned for transmission from Tx device 260-1 to OADM 275, where super-channel 265-1 may be dropped. As further shown, OADM 275 may add super-channel 265-1′ to the fiber. Super-channel 265-1′ may include one or more optical channels at the same or substantially the same wavelengths as super-channel 265-1. Super-channel 265-1′ and super-channels 265-2 through 265-M may propagate to demultiplexer 280.

Demultiplexer 280 may include, for example, an optical de-multiplexer (e.g., an arrayed waveguide grating) that separates multiple super-channels 265 carried over an input fiber. For example, demultiplexer 280 may separate super-channels 265-1′ and super-channels 265-2 through 265-M, and may provide each super-channel 265 to a corresponding Rx device 285.

Rx device 285 may include, for example, an optical receiver and/or an optical transceiver that receives an optical signal. For example, Rx device 285 may include one or more integrated circuits, such as a receiver PIC, an ASIC, or the like. In some implementations, Rx device 285 may include a demultiplexer to receive combined output and demultiplex the combined output into individual optical signals, a photodetector to convert an optical signal to a voltage signal, an analog-to-digital converter to convert voltage signals to digital signals, and/or a digital signal processor to process the digital signals. One or more optical signals may be received by Rx device 285 via super-channel 265. Rx device 285 may convert a super-channel 265 into one or more electrical signals, which may be processed to output information associated with each data stream carried by an optical channel included in super-channel 265. In some implementations, a single Rx device 285 may be associated with a single super-channel 265. In some implementations, a single Rx device 285 may be associated with multiple super-channels 265, or multiple Rx devices 285 may be associated with a single super-channel 265.

One or more devices shown in FIG. 2B may be an optical device 250. In some implementations, a combination of devices shown in FIG. 2B may be an optical device 250. For example, Tx devices 260-1 through 260-M and multiplexer 270 may be an optical device 250. As another example, Rx devices 285-1 through 285-L and demultiplexer 280 may be an optical device 250.

The number and arrangement of devices shown in FIG. 2B are provided as an example. In practice, there may be additional devices, fewer devices, different devices, or differently arranged devices, included in optical network 240, than those shown in FIG. 2B. Furthermore, two or more devices shown in FIG. 2B may be implemented within a single device, or a single device shown in FIG. 2B may be implemented as multiple, distributed devices. Additionally, or alternatively, a set of devices shown in FIG. 2B may perform one or more functions described as being performed by another set of devices shown in FIG. 2B.

FIG. 2C is a diagram of example super-channels 265 that may be monitored and/or configured according to implementations described herein. A super-channel may refer to multiple optical channels that are simultaneously transported over the same optical waveguide (e.g., a single mode optical fiber). Each optical channel included in a super-channel may be associated with a particular optical wavelength (or set of optical wavelengths). The multiple optical channels may be combined to create a super-channel using wavelength division multiplexing. For example, the multiple optical channels may be combined using dense wavelength division multiplexing, in which channel-to-channel spacing may be less than 1 nanometer. In some implementations, each optical channel may be modulated to carry an optical signal.

FIG. 2C shows an example frequency and/or wavelength spectrum associated with super-channels 265. In some implementations, the frequency and/or wavelength spectrum may be associated with a particular optical spectrum (e.g., C Band, C+Band, CDC Band, etc.). As shown, super-channel 265-1 may include multiple optical channels 290, each of which corresponds to a wavelength λ (e.g., λ₁, λ₂, through λ₁₀) within a first wavelength band. Similarly, super-channel 265-M may include multiple optical channels 290, each of which corresponds to a wavelength λ (e.g., λ_{Y-X} through λ_{Y}) within a second wavelength band. The quantity of depicted optical channels 290 per super-channel 265 is provided as an example. In practice, super-channel 265 may include any quantity of optical channels 290.

Optical channel 290 may be associated with a particular frequency and/or wavelength of light. In some implementations, optical channel 290 may be associated with a frequency and/or wavelength at which the intensity of light carried by optical channel 290 is strongest (e.g., a peak intensity, illustrated by the peaks on each optical channel 290). In some implementations, optical channel 290 may be associated with a set of frequencies and/or a set of wavelengths centered at a central frequency and/or wavelength. The intensity of light at the frequencies and/or wavelengths around the central frequency and/or wavelength may be weaker than the intensity of light at the central frequency and/or wavelength, as illustrated.

In some implementations, the spacing between adjacent wavelengths (e.g., λ₁ and λ₂) may be equal to or substantially equal to a bandwidth (or bit rate) associated with a data stream carried by optical channel 290. For example, assume each optical channel 290 included in super-channel 265-1 (e.g., λ₁ through λ₁₀) is associated with a 50 Gigabit per second (“Gbps”) data stream. In this example, super-channel 265-1 may have a collective data rate of 500 Gbps (e.g., 50 Gbps×10). In some implementations, the collective data rate of super-channel 265 may be greater than or equal to 100 Gbps. Additionally, or alternatively, the spacing between adjacent wavelengths may be non-uniform, and may vary within a particular super-channel band (e.g., super-channel 265-1). In some implementations, optical channels 290 included in super-channel 265 may be non-adjacent (e.g., may be associated with non-adjacent wavelengths in an optical spectrum).

Each super-channel 265 may be provisioned in optical network 240 as one optical channel and/or as an individual optical channel. Provisioning of an optical channel may include designating a route for the optical channel through optical network 240. For example, an optical channel may be provisioned to be transmitted via a set of optical devices 250. In some implementations, optical devices 250 may be configured as a ring. Additionally, or alternatively, optical devices 250 may be configured in a point-to-point configuration. Provisioning may be referred to as “allocating” and/or “allocation” herein. Even though each super-channel 265 is a composite of multiple optical channels 290, the optical channels 290 included in super-channel 265 may be routed together through optical network 240. Additionally, or alternatively, super-channel 265 may be managed and/or controlled in optical network 240 as though super-channel 265 included one optical channel at one wavelength.

The number and arrangement of super-channels and optical channels shown in FIG. 2C are provided as an example. In practice, there may be additional super-channels and/or optical channels, fewer super-channels and/or optical channels, different super-channels and/or optical channels, or differently arranged super-channels and/or optical channels than those shown in FIG. 2C.

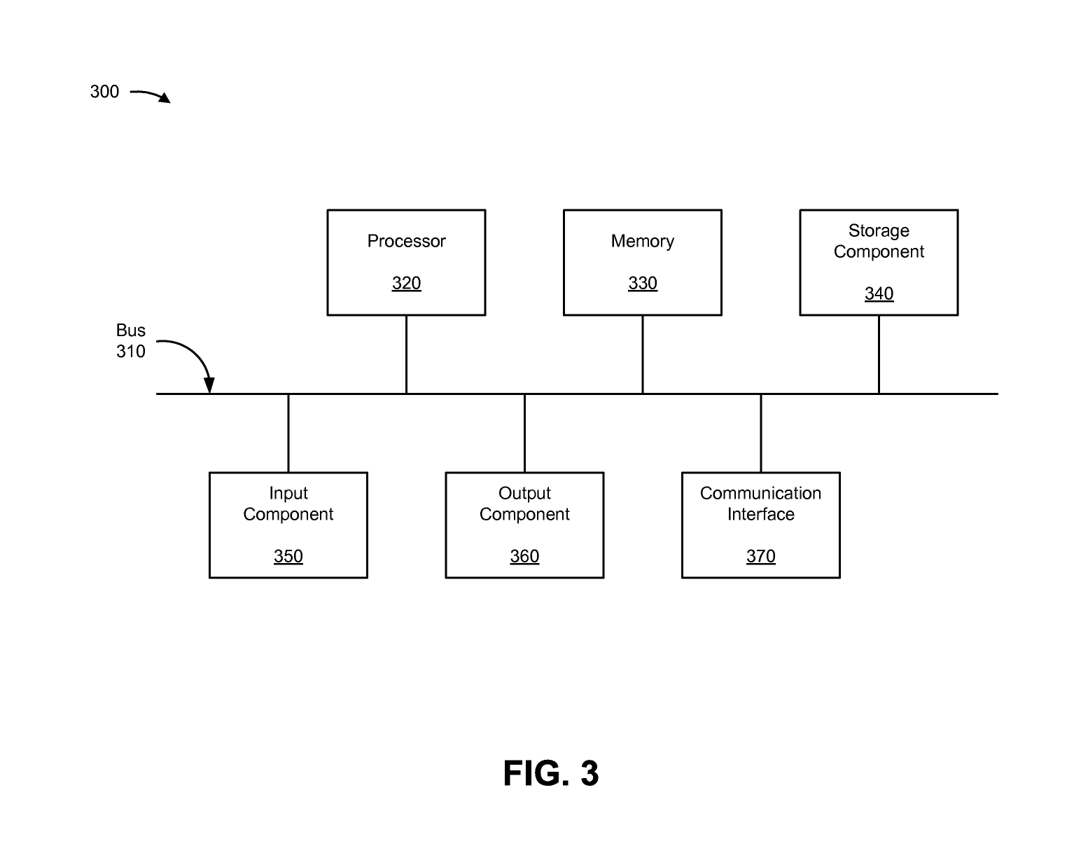

FIG. 3 is a diagram of example components of a device 300. Device 300 may correspond to network planning system 210, network administrator device 220, and/or user device 230. In some implementations, network planning system 210, network administrator device 220, and/or user device 230 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 may include a component that permits communication among the components of device 300. Processor 320 may include a processor (e.g., a central processing unit (CPU), a graphics processing unit (GPU), an accelerated processing unit (APU), etc.), a microprocessor, and/or any processing component (e.g., a field-programmable gate array (FPGA), an application-specific integrated circuit (ASIC), etc.) that interprets and/or executes instructions. Memory 330 may include a random access memory (RAM), a read only memory (ROM), and/or another type of dynamic or static storage device (e.g., a flash memory, a magnetic memory, an optical memory, etc.) that stores information and/or instructions for use by processor 320.

Storage component 340 may store information and/or software related to the operation and use of device 300. For example, storage component 340 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 350 may include a component that permits device 300 to receive information, such as via user input (e.g., a touch screen display, a keyboard, a keypad, a mouse, a button, a switch, a microphone, etc.). Additionally, or alternatively, input component 350 may include a sensor for sensing information (e.g., a global positioning system (GPS) component, an accelerometer, a gyroscope, an actuator, etc.). Output component 360 may include a component that provides output information from device 300 (e.g., a display, a speaker, one or more light-emitting diodes (LEDs), etc.).

Communication interface 370 may include a transceiver-like component (e.g., a transceiver, a separate receiver and transmitter, etc.) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes in response to processor 320 executing software instructions stored by a computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

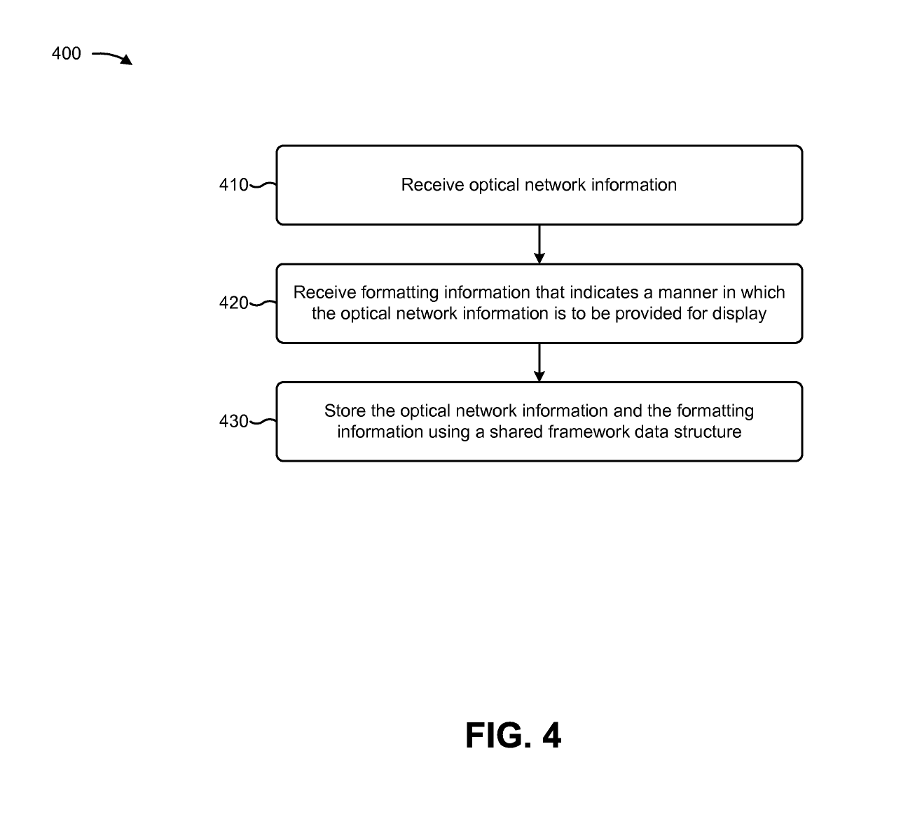

FIG. 4 is a flow chart of an example process 400 for receiving and storing optical network information and formatting information that controls a manner in which the optical network information is provided for display. In some implementations, one or more process blocks of FIG. 4 may be performed by network administrator device 220. In some implementations, one or more process blocks of FIG. 4 may be performed by another device or a group of devices separate from or including network administrator device 220, such as network planning system 210, user device 230, and/or optical device 250.

As shown in FIG. 4, process 400 may include receiving optical network information (block 410). For example, network administrator device 220 may receive optical network information (e.g., from network planning system 210, optical device 250, etc.). In some implementations, network administrator device 220 may request and/or receive the optical network information on a periodic basis (e.g., every second, every minute, every hour, every day, every week, etc.). Additionally, or alternatively, network administrator device 220 may request and/or receive the optical network information based on input received from a user (e.g., a user request for the optical network information). Additionally, or alternatively, network planning system 210, user device 230, and/or optical device 250 may automatically provide the optical network information to network administrator device 220 (e.g., on a periodic basis, based on occurrence of an event, when the optical network information is modified, etc.).

Optical network information may include information associated with optical network 240, such as information associated with one or more optical devices 250, one or more optical components included in one or more optical devices, one or more optical super-channels carried by one or more optical components, one or more optical channels included in one or more optical superchannels, one or more optical links between optical devices 250, or the like.

As further shown in FIG. 4, process 400 may include receiving formatting information that indicates a manner in which the optical network information is to be provided for display (block 420). For example, network administrator device 220 may receive formatting information (e.g., based on user input, based on input received from another device, etc.). The formatting information may include information that identifies a manner in which the optical network information is to be presented for display. In some implementations, network administrator device 220 may receive different formatting information associated with different applications, where the formatting information indicates a manner in which the optical network information is to be presented for display via the application.

As an example, the formatting information may indicate a type of optical network information to be presented for display (e.g., out of all available optical network information), whether particular optical network information is to be presented for display via a user interface, a position where the optical network information is to be presented via a user interface, a representation to be used to provide the optical network information for display, or the like.

As further shown in FIG. 4, process 400 may include storing the optical network information and the formatting information using a shared framework data structure (block 430). For example, network administrator device 220 may store the optical network information and/or the formatting information in a memory accessible by network administrator device 220 and/or user device 230. Additionally, or alternatively, network administrator device 220 may store a relationship indicator that indicates a relationship between formatting information and an application for which the formatting information is to be applied (and/or a user device 230 for which the formatting information is to be applied). In some implementations, network administrator device 220 may store the information in a data structure. Network administrator device 220 may organize the data structure such that the optical network information may be used by multiple applications, as described in more detail elsewhere herein.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

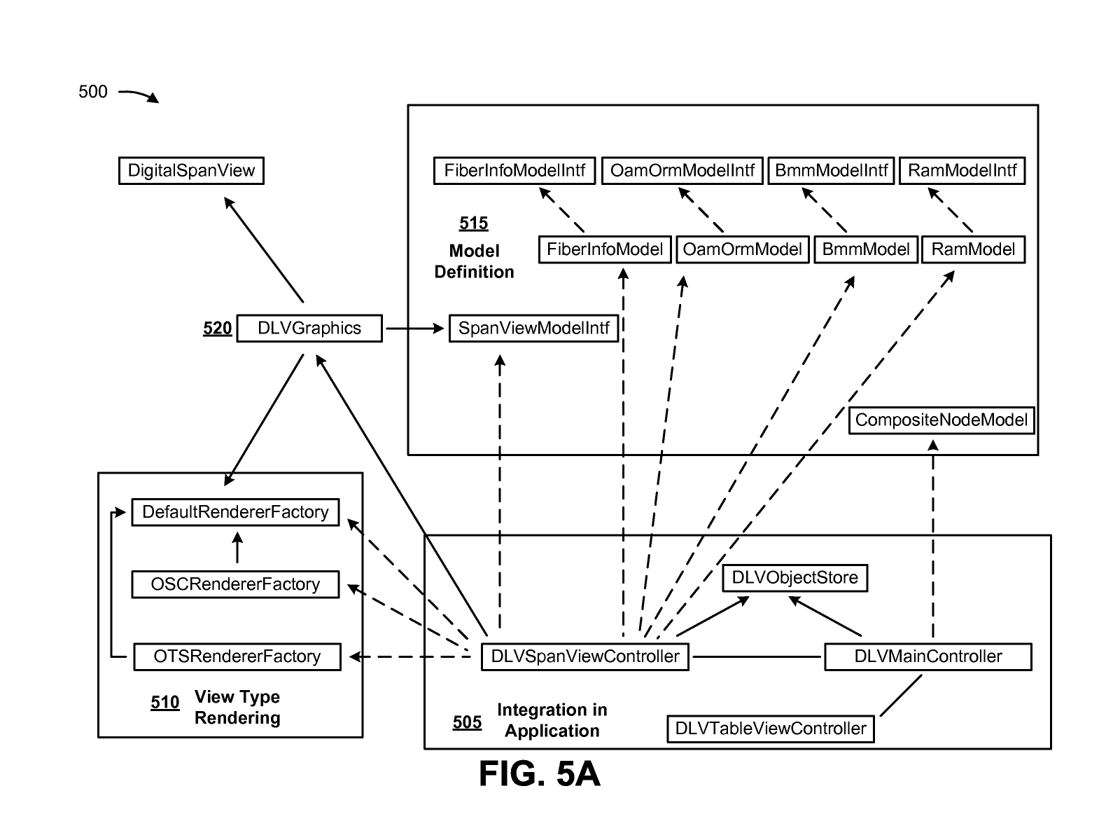

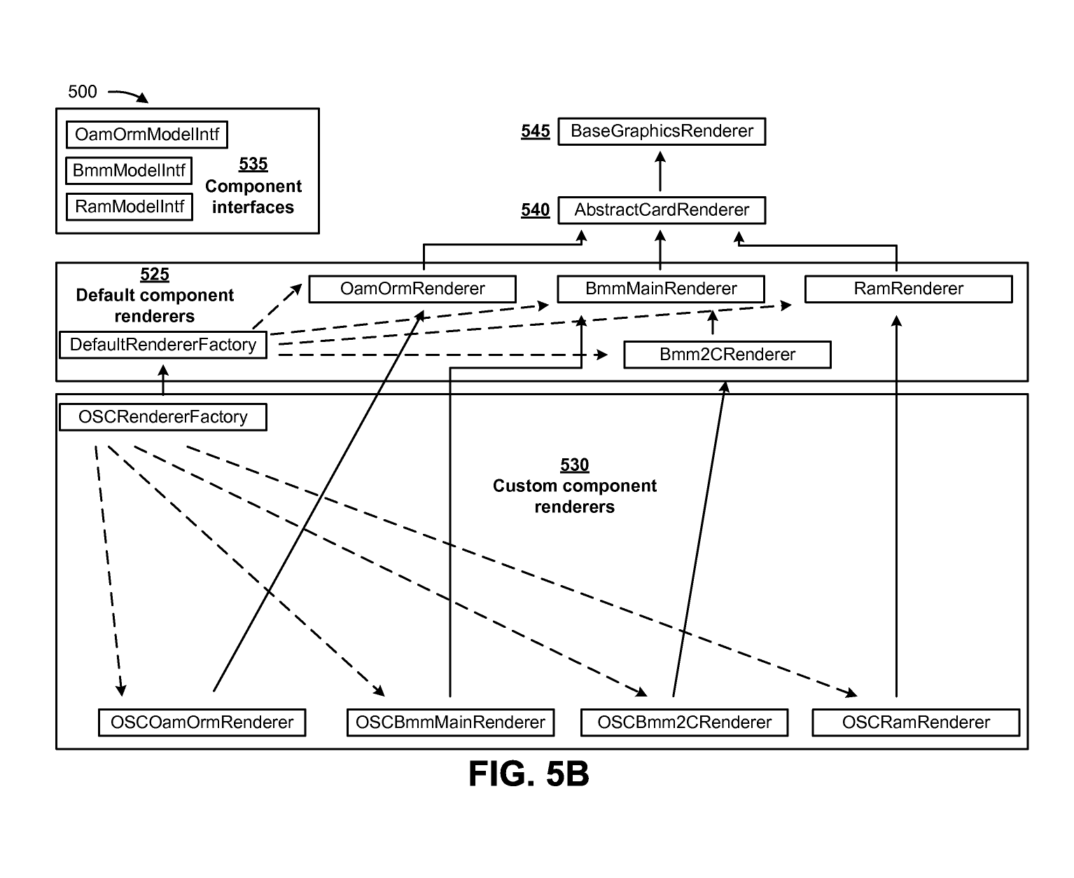

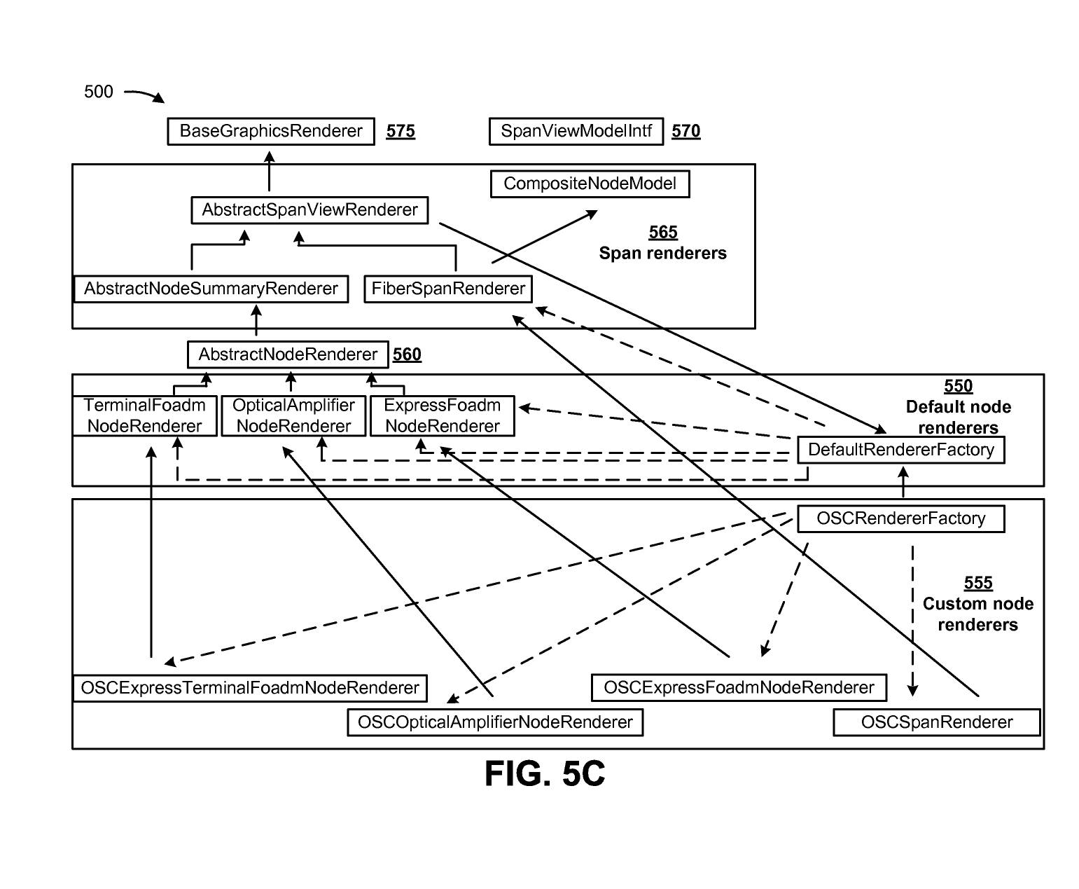

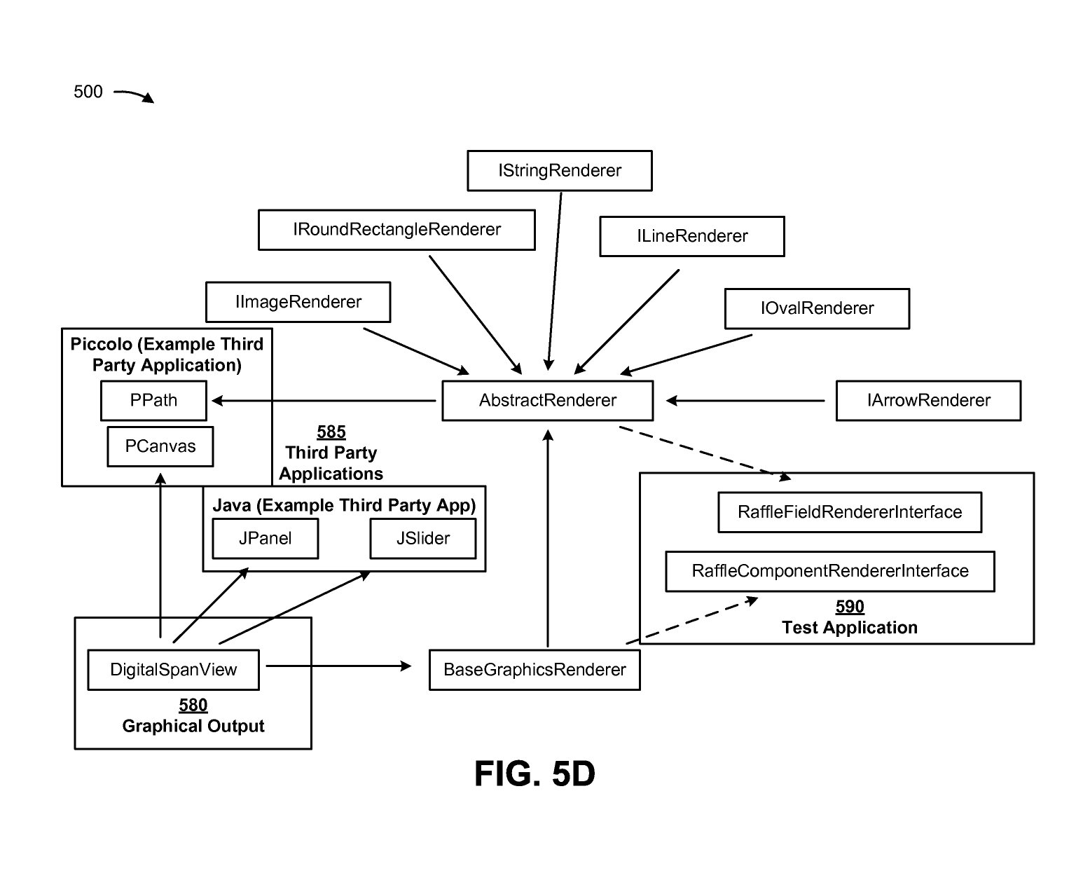

FIGS. 5A-5D are diagrams of an example implementation relating to the example process shown in FIG. 4. FIGS. 5A-5D show example class diagrams that may be used by user device 230 to organize optical network information and formatting information using a shared framework data structure.

As shown in FIG. 5A, and by reference number 505, the shared framework data structure may include integration classes for integrating the optical network information and the formatting information with an application. The integration classes may be associated with a particular application, and user device 230 may use these classes to apply formatting information to control a manner in which optical network information is presented in the particular application.

For example, the integration classes may include a span view controller class (shown as DLVSpanViewController) to apply the formatting information when presenting the optical network information in a graphical span view (e.g., a view that depicts two or more optical devices 250 and optical link(s) between the optical devices 250), a table view controller class (shown as DLVTableViewController) to apply the formatting information when presenting the optical network information in a tabular view (e.g., a view that depicts optical network information using a table), an object store class (shown as DLVObjectStore) to store objects (e.g., objects created using the optical network information and/or the formatting information), a main controller class (shown as DLVMainController) to integrate the span view controller class, the table view controller class, and/or the object store class, or the like.

As shown by reference number 510, the shared framework data structure may include rendering classes that control rendering of optical network information (e.g., based on formatting information). The rendering classes may be associated with different graphical views in an application, and user device 230 may use these classes to control a manner in which optical network information is rendered in a particular graphical view. In some implementations, the rendering classes may include the formatting information.

For example, the rendering classes may include a default renderer (shown as DefaultRendererFactory) that controls a manner in which optical network information is rendered by default (e.g., when a user does not create a custom view, when an application is not associated with a custom view, etc.). Additionally, or alternatively, the rendering classes may include one or more custom renderers that override the default renderer to control a manner in which optical network information is rendered for a particular application and/or view. As an example, the custom renderer may include an optical supervisory channel (“OSC”) renderer (shown as OSCRendererFactory) to control a manner in which optical network information is rendered in an OSC view, an optical transmission section (“OTS”) renderer (shown as OTSRendererFactory) to control a manner in which optical network information is rendered in an OTS view, or the like.

As shown, the span view controller class may interact with the rendering classes to apply a particular renderer class, that includes formatting information, to a particular application to control a manner in which optical network information is presented for display in the particular application.

As shown by reference number 515, the shared framework data structure may include model definition classes that store optical network information associated with different types of optical equipment. Optical equipment may include, for example, optical device 250, an optical component included in optical device 250, an optical link that connects multiple optical devices 250, an optical super-channel, an optical channel, or the like. A model definition class may be associated with a particular type of optical equipment, and may store optical network information regarding the optical equipment.

For example, the model definition classes may include a fiber model (shown as FiberInfoModel) that stores optical network information associated with an optical link between network nodes 250 (e.g., a power characteristic of the optical link, information that identifies optical devices 250 connected via the optical link, a span loss parameter associated with the optical link, an error associated with the optical link, etc.), an optical amplifier module (“OAM”) model (shown as OamOrmModel) that stores optical network information associated with an OAM (e.g., a characteristic of the OAM, a capability of the OAM, an error associated with the OAM, etc.), a band multiplexing module (“BMM”) model (shown as BmmModel) that stores optical network information associated with a BMM (e.g., a characteristic of the BMM, a capability of the BMM, an error associated with the BMM, etc.), a Raman amplifier module (“RAM”) model (shown as RamModel) that stores optical network information associated with a RAM (e.g., a characteristic of the RAM, a capability of the RAM, an error associated with the RAM, etc.), or the like.

Additionally, or alternatively, the model definition classes may include a composite node model (shown as CompositeNodeModel) that stores optical network information associated with optical device 250. As an example, optical device 250 may include multiple optical components (e.g., OAMs, BMMs, RAMs, etc.), and the composite node model may store information that identifies the quantities and types of optical components included in optical device 250. Additionally, or alternatively, the model definition classes may include a span view model interface (shown as SpanViewModelIntf) to implement the model definitions.

As shown by reference number 520, the shared framework data structure may include a graphics class (shown as DLVGraphics) that interacts with the model definition classes, the rendering classes, and/or the integration classes to share information for rendering optical network information (e.g., stored by the model definition classes) for display based on formatting information (e.g., stored by the rendering classes). The graphics class may integrate the optical network information and formatting information with a particular application via the span view controller, a digital span view class (shown as DigitalSpanView), or the like.

By organizing information using a shared framework data structure, user device 230 may store optical network information, formatting information, and application information separately. This may permit the optical network information and formatting information to be applied in a different manner in different applications. Thus, user device 230 may format optical network information for display based on the needs or purposes of a particular application.

FIG. 5B shows an example of how the shared framework data structure may be organized with respect to optical components (e.g., OAMs, BMMs, RAMs, etc.). As shown in FIG. 5B, and by reference number 525, the shared framework data structure may include default component renderers that control a manner in which optical components are rendered by default (e.g., when a user does not create a custom view, when an application is not associated with a custom view, etc.), as described in connection with reference number 510 of FIG. 5A. The default component renderer may include default renderers for different types of optical components, such as OAMs, BMMs, RAMs, or the like.

As shown by reference number 530, the shared framework data structure may include one or more custom component renderers that override the default component renderers to control a manner in which optical components are rendered for a particular application and/or view, as described in connection with reference number 510 of FIG. 5A. As an example, a custom component renderer may include an optical supervisory channel (“OSC”) renderer to control a manner in which different optical components (e.g., OAMs, BMMs, RAMs, etc.) are rendered in an OSC view.

As shown by reference number 535, the shared framework data structure may include one or more component interfaces that may be implemented by an application to use the shared framework data structure for a particular type of component. For example, a component interface may provide access to the shared framework data structure. As shown by reference number 540, the default component renderers and/or the custom component renderers may be sub-classes of an abstract card renderer class that includes class information common to the sub-classes. In this way, the shared framework data structure may permit re-use of information common to the sub-classes, thereby conserving computing resources.

As shown by reference number 545, the abstract card renderer class may be a sub-class of a base graphics renderer class that may be used to output optical network information (e.g., for rendering), in a particular format, to different applications, as described in more detail elsewhere herein. By organizing formatting information in this manner, user device 230 may reuse the formatting information across different applications.

FIG. 5C shows an example of how the shared framework data structure may be organized with respect to optical devices 250 (e.g., an OADM, a ROADM, a FROADM, an optical amplifier node, a terminal node at which an optical route begins or ends, an express node that does not permit adding or dropping of channels or super-channels, etc.). As shown in FIG. 5C, and by reference number 550, the shared framework data structure may include default node renderers that control a manner in which optical devices 250 are rendered by default, as described in connection with reference number 510 of FIG. 5A. The default component renderer may include default renderers for different types of optical devices 250, such as terminal FROADMs, optical amplifier nodes, express FROADMs, or the like.

As shown by reference number 555, the shared framework data structure may include one or more custom node renderers that override the default node renderers to control a manner in which optical devices 250 are rendered for a particular application and/or view, as described in connection with reference number 510 of FIG. 5A. As an example, a custom node renderer may include an optical supervisory channel (“OSC”) renderer to control a manner in which different optical devices 250 are rendered in an OSC view.

As shown by reference number 560, the default component renderers and/or the custom component renderers may be sub-classes of an abstract node renderer class that includes class information common to the sub-classes. As shown by reference number 565, the shared framework data structure may include span renderers that control a manner in which optical spans are rendered. An optical span may include multiple optical devices 250 and optical links between optical devices 250.

As shown by reference number 570, the shared framework data structure may include one or more span interfaces that may be implemented by an application to use the shared framework data structure for a particular optical device 250 and/or optical span. As shown by reference number 575, the shared framework data structure may include a base graphics renderer class that may be used to output optical network information (e.g., for rendering), in a particular format, to different applications, as also shown in connection with reference number 545 of FIG. 5B. By organizing formatting information in this manner, user device 230 may reuse the formatting information across different applications.

FIG. 5D shows an example of how the shared framework data structure may be used to output optical network information, in a particular format, to different applications. As shown, the shared framework data structure may use a base graphics renderer (as described elsewhere herein in connection with FIG. 5B and FIG. 5C) to output optical network information to different applications (e.g., for rendering, for processing, etc.).

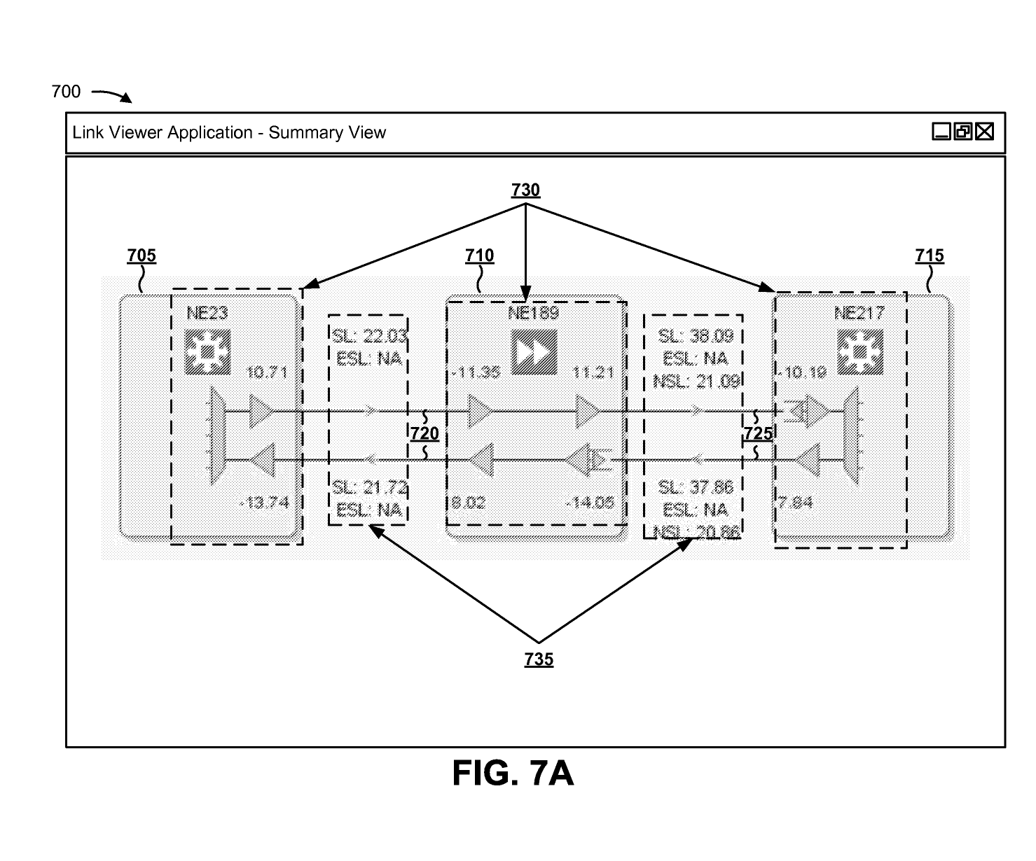

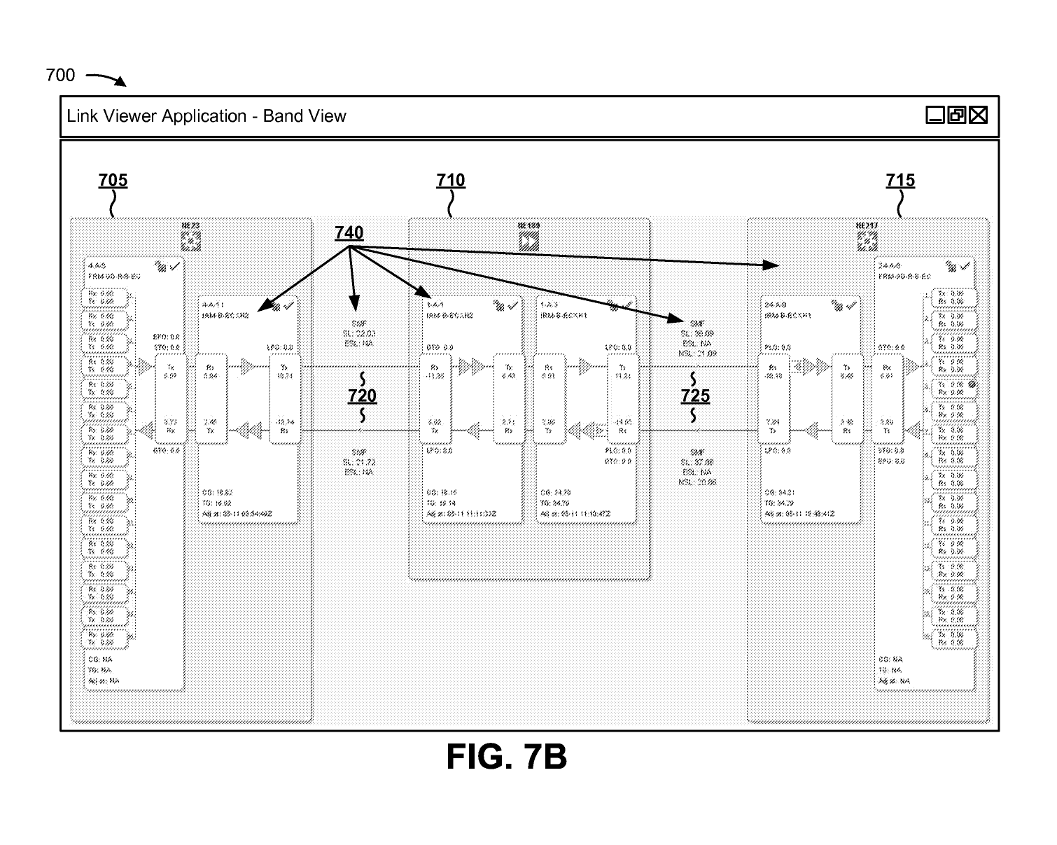

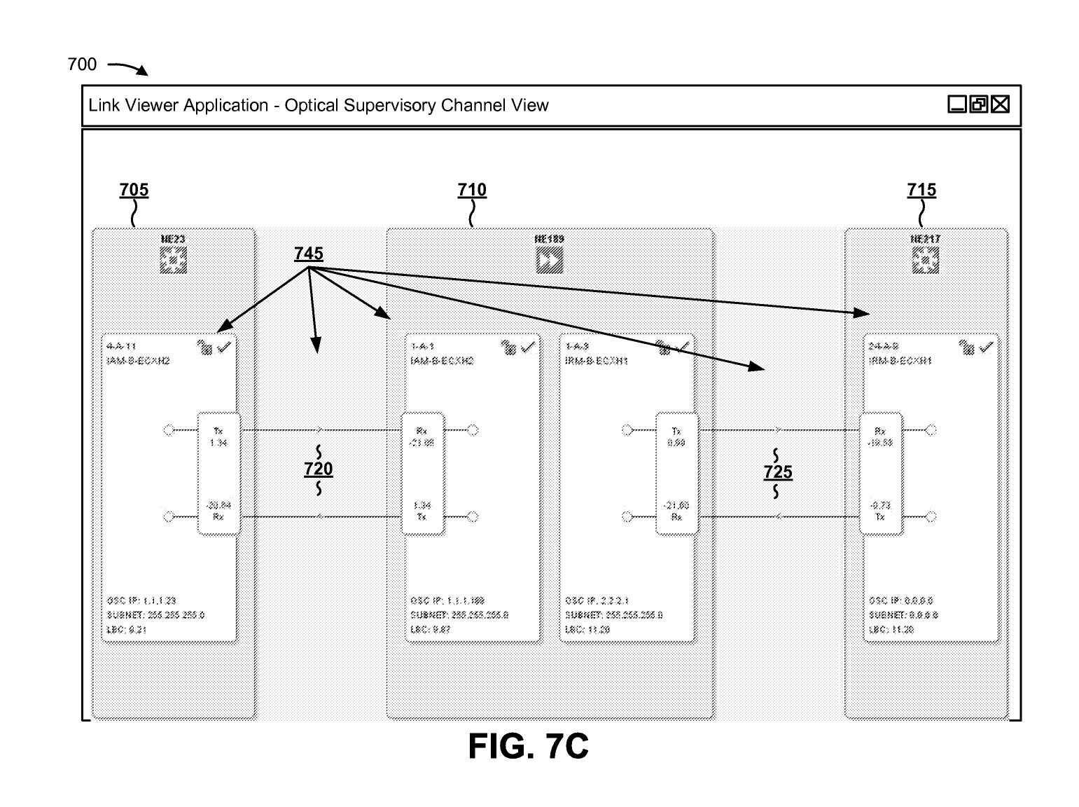

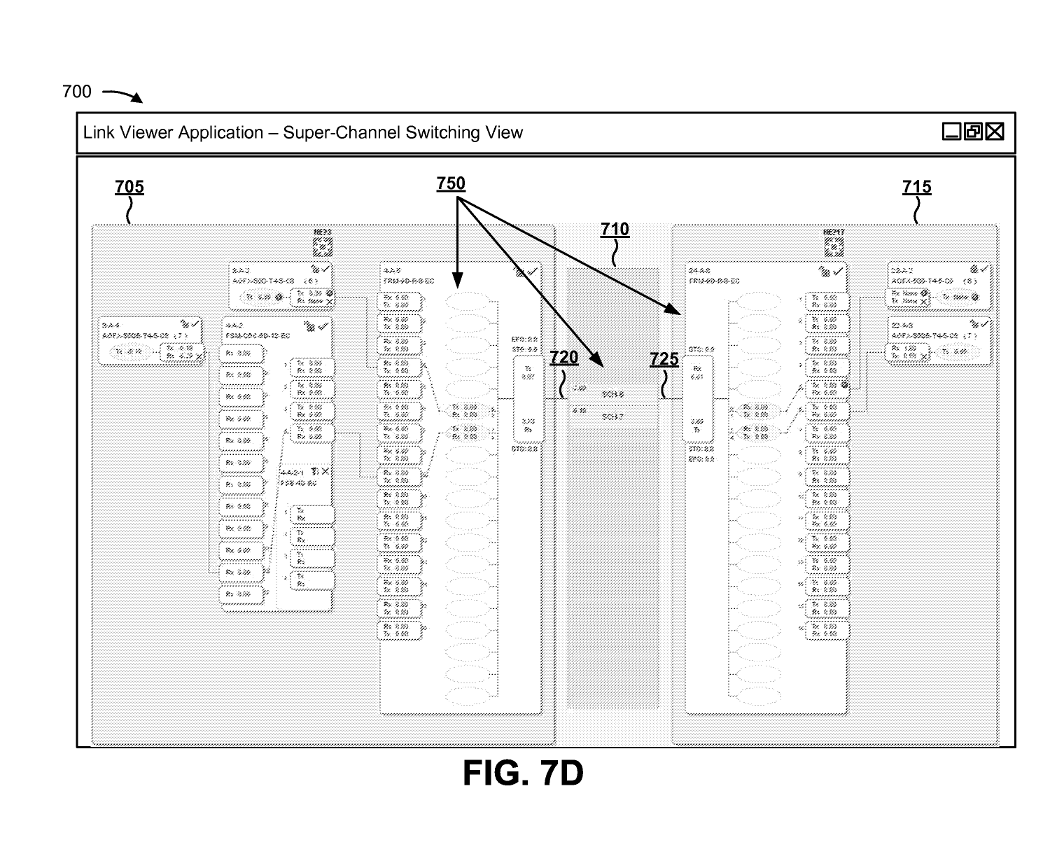

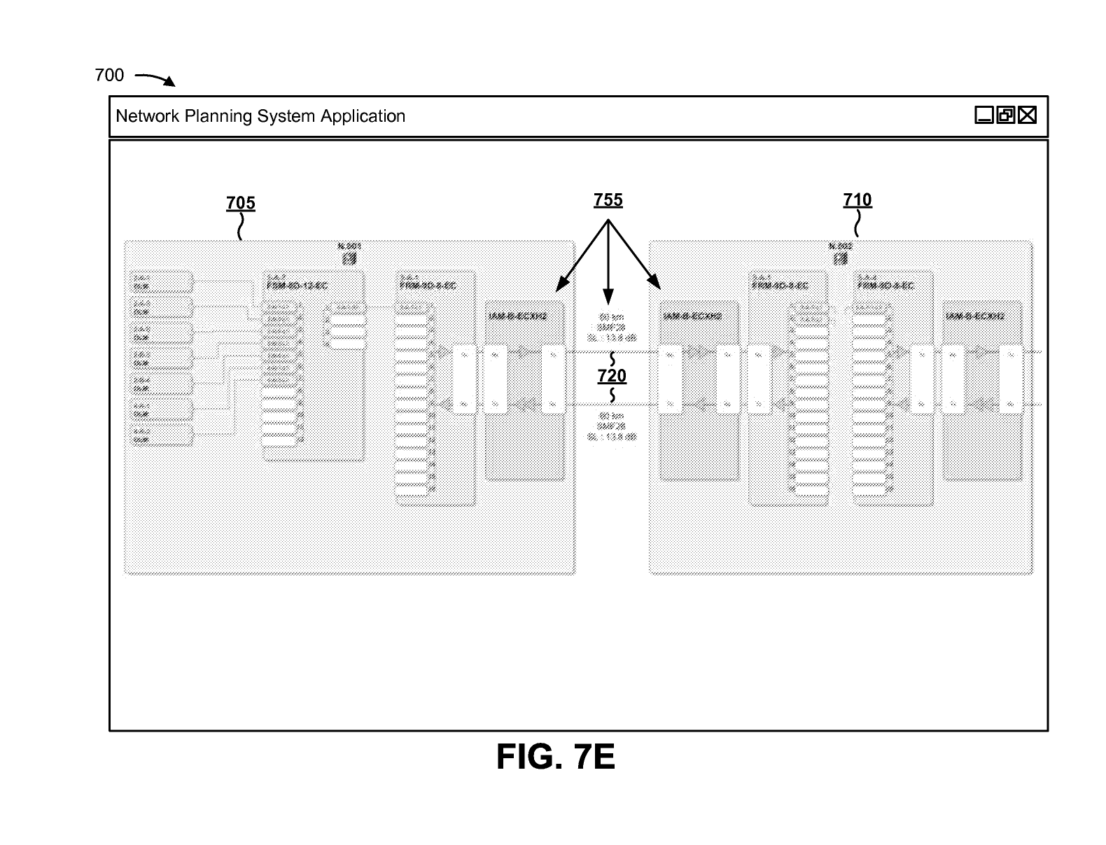

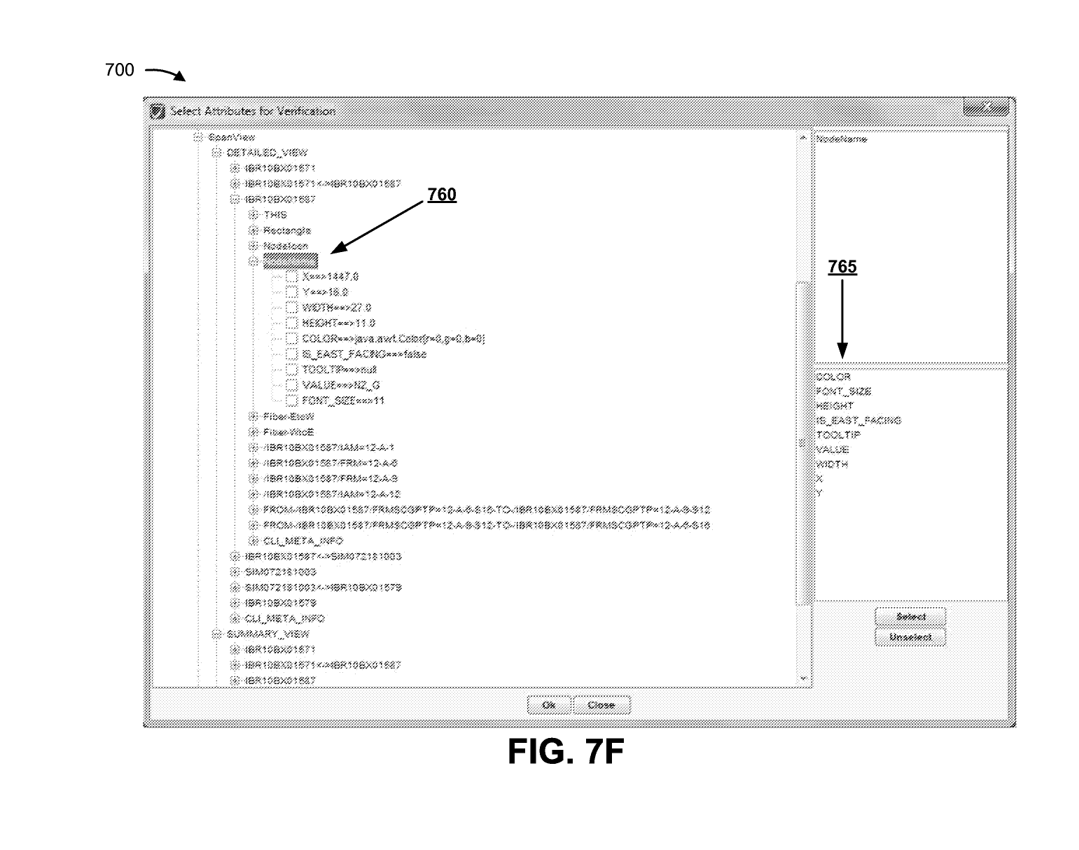

As shown by reference number 580, the base graphics renderer may interact with a digital span view class (e.g., as shown in FIG. 5A) to integrate formatting information with a particular application. As shown by reference number 585, the base graphics renderer may interact with one or more third party rendering classes (e.g., Java classes, Piccolo classes, JGraph classes, Ilog classes, JavaFX classes, or other third party graphical rendering classes or canvases) to integrate formatting information with a particular third party application. As shown by reference number 590, the base graphics renderer may interact with one or more test application classes (e.g., associated with one or more test automation applications, such as RAFFLE, described in more detail in connection with FIG. 7F) to integrate formatting information with a particular test application. In this way, user device 230 may use the shared framework data structure to control a manner in which optical network information is formatted (e.g., for rendering) across different applications that use the optical network information.

As indicated above, FIGS. 5A-5D are provided merely as examples. Other examples are possible and may differ from what was described with regard to FIGS. 5A-5D.

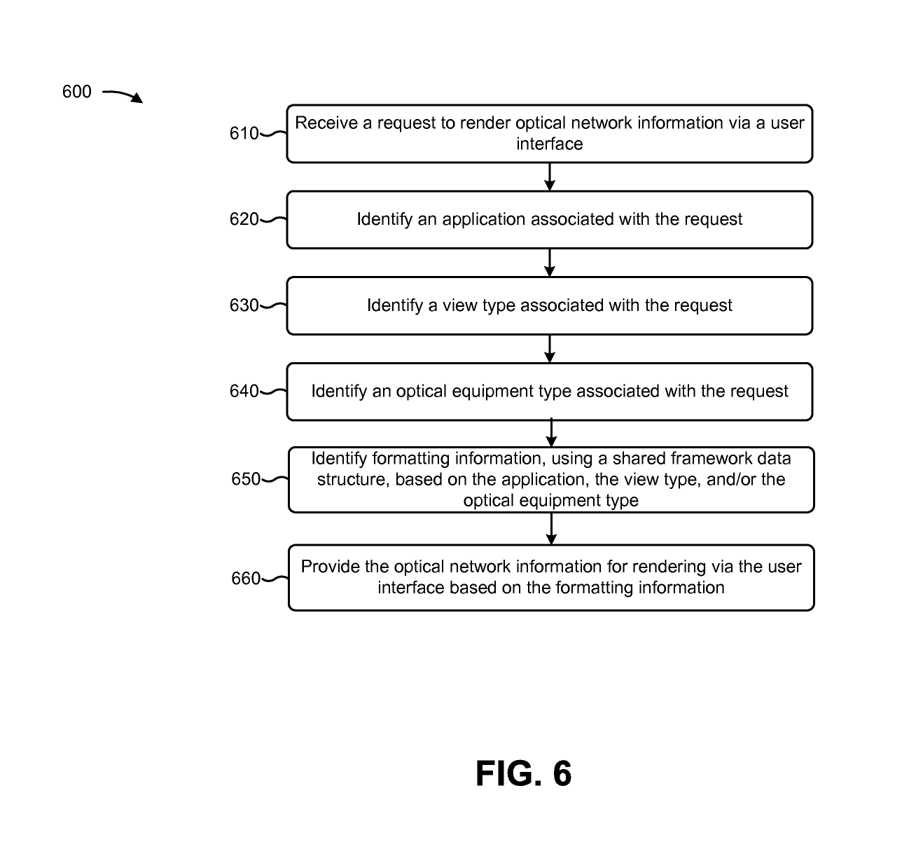

FIG. 6 is a flow chart of an example process 600 for providing optical network information for rendering via a user interface based on formatting information. In some implementations, one or more process blocks of FIG. 6 may be performed by network administrator device 220. In some implementations, one or more process blocks of FIG. 6 may be performed by another device or a group of devices separate from or including network administrator device 220, such as network planning system 210, user device 230, and/or optical device 250.

As shown in FIG. 6, process 600 may include receiving a request to render optical network information via a user interface (block 610), and identifying an application associated with the request (block 620). For example, network administrator device 220 may receive a request for optical network information. Network administrator device 220 may receive the request based on user input and/or input received from another device (e.g., user device 230). In some implementations, the request may be associated with and/or may be received from an application (e.g., a software application). For example, the user may provide input to execute (e.g., open, load, etc.) an application that provides optical network information for display, and network administrator device 220 may receive the request from the application. Network administrator device 220 may identify the application associated with the request (e.g., based on information received from user device 230).

As further shown in FIG. 6, process 600 may include identifying a view type associated with the request (block 630). For example, network administrator device 220 may identify a view type, associated with the request, via which the optical network information is to be rendered. In some implementations, network administrator device 220 may identify the view type based on the application, based on user input, based on information received from another device (e.g., user device 230), or the like. For example, network administrator device 220 may receive the request from the application, and the application may be associated with a single view type. Additionally, or alternatively, the request may indicate the view type. For example, the user may provide input to request optical network information via a particular view type, and network administrator device 220 may identify the view type.

A view type may include, for example, a summary view that provides high-level summary information relating to one or more optical devices 250 and/or optical links included in an optical route, a detailed view that provides low-level detailed information relating to optical devices 250 (e.g., optical components included in optical device 250) and/or optical links, a super-channel view that provides super-channel information relating to one or more super-channels configured on optical device 250 and/or an optical link, a channel view that provides channel information relating to one or more channels (e.g., a digital channel) included in a super-channel, or the like.

As further shown in FIG. 6, process 600 may include identifying an optical equipment type associated with the request (block 640). For example, network administrator device 220 may identify an optical equipment type to be rendered for display. In some implementations, the optical equipment type may be identified in the request. For example, the user may provide input to request optical network information associated with a particular optical span that includes one or more optical devices 250 and/or optical links. Network administrator device 220 may identify an optical equipment type of the optical devices 250 and/or the optical links.

An optical equipment type may include, for example, an optical device type (e.g., an OADM, a ROADM, a FROADM, an optical amplifier node, a terminal node, an express node, etc.), an optical component type (e.g., an OAM, a BMM, a RAM, etc.), an optical channel type (e.g., a super-channel, a channel, etc.), or the like.

As further shown in FIG. 6, process 600 may include identifying formatting information, using a shared framework data structure, based on the application, the view type, and/or the optical equipment type (block 650). For example, network administrator device 220 may identify formatting information, that controls a manner in which optical equipment is represented via a user interface, based on the application, the view type, and/or the optical equipment type. In some implementations, network administrator device 220 may identify the formatting information based on the application and the optical equipment type. Additionally, or alternatively, network administrator device 220 may identify the formatting information based on the application, the view type, and the optical equipment type. In this way, network administrator device 220 may customize a manner in which optical network information is provided for display (e.g., by network administrator device 220, by user device 230, etc.).

Network administrator device 220 may identify the formatting information based on information stored in a shared framework data structure, in some implementations. For example, network administrator device 220 may store a relationship indicator that indicates a relationship between the formatting information and the application, the view type, and/or the optical equipment type. In some implementations, network administrator device 220 may identify default formatting information (e.g., stored by a default renderer class) associated with the application, view type, and/or optical equipment type. Additionally, or alternatively, network administrator device 220 may identify custom formatting information (e.g., stored by a custom renderer class) associated with the application, view type, and/or optical equipment type.

As further shown in FIG. 6, process 600 may include providing the optical network information for rendering via the user interface based on the formatting information (block 660). For example, network administrator device 220 may provide the requested optical network information for rendering via a user interface. In some implementations, network administrator device 220 may provide the optical network information to user device 230 for rendering by user device 230. Network administrator device 220 may also provide the formatting information to control a manner in which the requested optical network information is rendered via the user interface. Additionally, or alternatively, network administrator device 220 may provide the optical network information in a particular format for exporting to an application (e.g., an image format, a test automation format, or the like). In this way, the same optical network information (or different subsets of optical network information) may be provided for display in a different manner based on an application requesting the optical network information, a view type of a user interface that provides the optical network information for display, or the like.

Additionally, or alternatively, network administrator device 220 may determine one or more configuration parameters, and may use the configuration parameters to determine information to be provided via the user interface. For example, a configuration parameter may include a tool tip (e.g., information provided for display when a cursor hovers over a representation of optical equipment), an indication of whether a user is permitted to zoom for a particular application and/or view, or the like. In this way, the user may customize the user interface based on the user's preferences.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

FIGS. 7A-7F are diagrams of an example implementation 700 relating to example process 600 shown in FIG. 6. FIGS. 7A-7F show example user interfaces associated with different applications and/or view types, and optical network information that is presented differently based on the application and/or view type in which the optical network information is presented.

FIG. 7A shows an example summary view, in a link viewer application, for providing optical network information. As shown, user device 230 provides a representation of a first node 705, a second node 710, a third node 715, a first link 720, and a second link 725 for display via the summary view of the link viewer application. User device 230 may determine these representations, and may provide these representations, based on formatting information associated with the link viewer application and the summary view. In this way, user device 230 may use a shared framework to render graphical representations of optical equipment via a particular application and/or view, based on a purpose associated with that application and/or view.

As shown by reference number 730, user device 230 provides optical network information (e.g., optical device identifiers, icons associated with an optical device type, parameter values, etc.) associated with first node 705, second node 710, and third node 715. User device 230 may determine the type and arrangement of this optical network information, and may provide the optical network information for display, based on formatting information associated with the link viewer application and the summary view. In this way, user device 230 may provide optical network information, associated with optical device 250, based on a purpose of an application and/or view via which the optical network information is provided for display.

As shown by reference number 735, user device 230 provides optical network information associated with first link 720 and second link 725. User device 230 may determine the type and arrangement of this optical network information, and may provide the optical network information for display, based on formatting information associated with the link viewer application and the summary view. In this way, user device 230 may provide optical network information, associated with an optical link, based on a purpose of an application and/or view via which the optical network information is provided for display.

FIG. 7B shows an example band view, in the link viewer application, for providing optical network information. As shown, user device 230 provides a different representation (e.g., different from the summary view) of first node 705, second node 710, third node 715, first link 720, and second link 725 in the band view of the link viewer application. As shown by reference number 740, user device 230 also provides different optical network information, associated with the displayed nodes and links, for display via the band view (e.g., different from the summary view). The band view and the summary view may be used to view different levels of optical network information, and user device 230 may use a shared framework to manage optical network information for each view, thereby saving computing resources.

FIG. 7C shows an example optical supervisory channel (OSC) view, in the link viewer application, for providing optical network information. As shown, user device 230 provides a different representation (e.g., different from the summary view and the band view) of first node 705, second node 710, third node 715, first link 720, and second link 725 in the OSC view of the link viewer application. As shown by reference number 745, user device 230 also provides different optical network information, associated with the displayed nodes and links, for display via the OSC view (e.g., different from the summary view and the band view). For example, in this case, user device 230 does not provide any optical network information associated with first link 720 or second link 725 (other than the representation of first link 720 and second link 725).

FIG. 7D shows an example super-channel switching view, in the link viewer application, for providing optical network information. As shown, user device 230 provides a different representation (e.g., different from the summary view, the band view, and the OSC view) of first node 705, second node 710, third node 715, first link 720, and second link 725 in the super-channel switching view of the link viewer application. As shown by reference number 750, user device 230 also provides different optical network information, associated with the displayed nodes and links, for display via the super-channel switching view (e.g., different from the summary view, the band view, and the OSC view).

FIG. 7E shows an example user interface, in a network planning system application, for providing optical network information. As shown, user device 230 provides a different representation (e.g., different from the link viewer application) of first node 705, second node 710, and first link 720, in the network planning system application. As shown by reference number 755, user device 230 also provides different optical network information, associated with the displayed nodes and links, for display via the user interface of the network planning system application (e.g., different from the views of the link viewer application). In this case, the network planning system application may be used to provision optical routes in an optical network, and the link viewer application may be used to diagnose problems associated with the optical network. User device 230 may use a shared framework to manage optical network information for each application, thereby saving computing resources (e.g., memory, processing power, etc.) while flexibly providing relevant information to each application.

FIG. 7F shows an example user interface, in a test automation application, for providing optical network information. As shown by reference number 760, user device 230 provides optical network information using a textual representation in the test automation application. Additionally, or alternatively, user device 230 may provide, as text, graphical view attributes, as shown by reference number 765. User device 230 may provide, via the test automation application, selectable items with which a user may interact in association with automated testing of the optical network.

In some implementations, two or more of the views shown in FIGS. 7A-7F may be provided in different sections of a single user interface (e.g., at the same time). In other words, user device 230 may use the shared framework data structure to provide optical network information (e.g., the same optical network information, different optical network information, the same optical network information presented in a different manner, etc.) via different sections of a single user interface.

As indicated above, FIGS. 7A-7F are provided merely as an example. Other examples are possible and may differ from what was described with regard to FIGS. 7A-7F.

Implementations described herein use a shared framework to store and organize optical network information for different graphical applications and/or for different user interface views within a single graphical application or across multiple graphical applications, resulting in more efficient use of computing resources.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, and/or a combination of hardware and software.

Certain user interfaces have been described herein and/or shown in the figures. A user interface may include a graphical user interface, a non-graphical user interface, a text-based user interface, etc. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A device, comprising:
one or more processors to:
receive a request to present, via a user interface, information associated with an optical network,
the information associated with the optical network being stored using a data structure accessible to provide the information to one or more applications associated with one or more view types;
identify an application, of the one or more applications, or a view type, of the one or more view types, associated with the user interface;
identify an optical equipment type associated with the request,
the optical equipment type identifying a type of optical equipment, associated with the optical network, to be presented for display via the user interface;
identify formatting information, for presenting optical network information associated with the optical equipment, based on the optical equipment type and at least one of:
the view type, or
the application; and
provide the optical network information, for presentation via the user interface, based on the formatting information.

2. The device of claim 1, where the optical network information identifies the optical equipment and the optical equipment type of the optical equipment.

3. The device of claim 1, where the one or more processors, when identifying the view type or the application, are further to:
identify an application that presents the user interface; and
where the one or more processors, when identifying the formatting information, are further to:
identify the formatting information based on the application that presents the user interface.

4. The device of claim 1, where the one or more processors, when identifying the view type or the application, are further to:
identify a view type of the user interface; and
where the one or more processors, when identifying the formatting information, are further to:
identify the formatting information based on the view type of the user interface.

5. The device of claim 1, where the formatting information identifies a manner in which a representation of the optical equipment is to be presented via the user interface; and
where the one or more processors, when providing the optical network information for presentation via the user interface, are further to:
provide the representation of the optical equipment for presentation via the user interface.

6. The device of claim 1, where the formatting information identifies the optical network information, associated with the optical equipment, to be presented via the user interface; and
where the one or more processors, when providing the optical network information for presentation via the user interface, are further to:
provide the optical network information identified by the formatting information for presentation via the user interface.

7. The device of claim 1, where the one or more processors, when identifying the application or the view type, are further to:
identify a first view type associated with the user interface; and
identify a second view type associated with the user interface,
the second view type being different than the first view type;
where the one or more processors, when identifying the formatting information, are further to:
identify first formatting information based on the first view type; and
identify second formatting information based on the second view type, the second formatting information being different from the first formatting information; and
where the one or more processors, when providing the optical network information for presentation via the user interface, are further to:
provide first optical network information, for presentation via a first section of the user interface, based on the first formatting information; and
provide second optical network information, for presentation via a second section of the user interface, based on the second formatting information,
the second section being different from the first section,
the second optical network information being presented in a different manner than the first optical network information based on the first formatting information and the second formatting information.

8. A computer-readable medium storing instructions, the instructions comprising:
one or more instructions that, when executed by one or more processors, cause the one or more processors to:
receive a request to render, via a user interface, information associated with an optical network,
the information associated with the optical network being stored using a data structure accessible to provide the information for rendering via one or more applications or one or more view types of the one or more applications;
identify an application, of the one or more applications, or a view type, of the one or more view types, associated with the user interface;
identify an optical equipment type associated with the request,
the optical equipment type identifying a type of optical equipment, associated with the optical network, to be rendered for display via the user interface;
identify formatting information, for rendering optical network information associated with the optical equipment, based on the optical equipment type and at least one of:
the view type, or
the application; and
provide the optical network information, for rendering via the user interface, based on the formatting information.

9. The computer-readable medium of claim 8, where the one or more instructions, that cause the one or more processors to identify the application or the view type, further cause the one or more processors to:
identify the application and the view type; and
where the one or more instructions, that cause the one or more processors to identify the formatting information, further cause the one or more processors to:
identify the formatting information based on the application and the view type.

10. The computer-readable medium of claim 8, where the optical equipment includes at least one of:
an optical device in the optical network,
an optical component included in the optical device, or
an optical link that connects at least two optical devices.

11. The computer-readable medium of claim 8, where the formatting information identifies a type of optical network information to be rendered via the user interface; and
where the one or more instructions, that cause the one or more processors to provide the optical network information for rendering via the user interface, further cause the one or more processors to:
provide the type of optical information to be rendered via the user interface.

12. The computer-readable medium of claim 8, where the formatting information identifies a position, within the user interface, where the optical network information is to be rendered; and
where the one or more instructions, that cause the one or more processors to provide the optical network information for rendering via the user interface, further cause the one or more processors to:
provide the formatting information that identifies the position where the optical network information is to be rendered,
the optical network information being rendered for display based on the position.

13. The computer-readable medium of claim 8, where the one or more instructions, that cause the one or more processors to provide the optical network information for rendering, further cause the one or more processors to:
provide first optical network information for rendering via a first section of the user interface; and
provide second optical network information for rendering via a second section of the user interface that is different from the first section,
the second optical network information being rendered in a manner that is different from the first optical network information and including different information than the first optical network information.

14. The computer-readable medium of claim 13, where the one or more instructions, when executed by the one or more processors, further cause the one or more processors to:
identify the first optical network information based on the formatting information and a first view type of the one or more view types; and
identify the second optical network information based on the formatting information and a second view type of the one or more view types,
the second view type being different than the first view type.

15. A method, comprising:
receiving, by a device, a request to provide information associated with an optical network,
the information associated with the optical network being stored using a data structure accessible to provide the information to one or more applications;
identifying, by the device, an application, of the one or more applications, to which the information associated with the optical network is to be provided;
identifying, by the device, an optical equipment type associated with the request,
the optical equipment type identifying a type of optical equipment associated with the optical network;
identifying, by the device, formatting information, for providing optical network information associated with the optical equipment to the application, based on the optical equipment type and the application; and
providing, by the device, the optical network information to the application based on the formatting information.

16. The method of claim 15, where providing the optical network information to the application further comprises:
providing the optical network information for display via the application.

17. The method of claim 15, where providing the optical network information to the application further comprises:
providing the optical network information for processing by the application.

18. The method of claim 15, further comprising:
identifying a view type associated with the application,
the view type being associated with a user interface or a section of the user interface;
where identifying the formatting information further comprises:
identifying the formatting information based on the view type; and
where providing the optical network information further comprises:
providing the optical network information, for presentation via the user interface or the section of the user interface, based on the formatting information.

19. The method of claim 15, where the optical network information includes at least one of:
information that identifies the optical equipment,
information that identifies a representation of the optical equipment, or
information that identifies a parameter or characteristic associated with the optical equipment.

20. The method of claim 15, where the formatting information identifies a representation of the optical equipment to be displayed by the application; and
where providing the optical network information to the application further comprises:
providing the formatting information that identifies the representation of the optical equipment,
the application providing the representation of the optical equipment for display.
